(19) United States
(12) Patent Application Publication
(10) Pub. No.: US 2014/0207504 A1
(43) Pub. Date: Jul. 24, 2014

(54) SYSTEM AND METHOD OF CALCULATING TASK EFFORTS AND APPLYING THE RESULTS FOR RESOURCE PLANNING

(71) Applicant: INTERNATIONAL BUSINESS MACHINES CORPORATION, Armonk, NY (US)

(72) Inventors: Kaan K. Katircioglu, Yorktown Heights, NY (US); Ying Li, Mohegan Lake, NY (US)

(73) Assignee: INTERNATIONAL BUSINESS MACHINES CORPORATION, Armonk, NY (US)

(21) Appl. No.: 13/746,014

(22) Filed: Jan. 21, 2013

(51) Int. Cl. G06Q 10/06

(52) U.S. Cl. CPC G06Q 10/06311
USPC 705/7.13

(57) ABSTRACT

A system and method of calculating task efforts and applying the results for resource planning. The method includes inputting ticket data into a computer, the computer having a processor for executing a software program tool embodied therein. The computer executes the steps of the software program tool to calculate the task effort value for each task handled by a consultant where the consultant has multiple tasks open during a defined period of time. The computer executes the steps of the software program tool to aggregate the task effort values for each consultant by workgroup resulting in the task effort value for the workgroup. The computer executes the steps of the software program tool to estimate the full time equivalent (FTE) for each workgroup as the ratio of the task effort value for the workgroup to the total available work hours for the FTE.

### FIELD

The present invention relates generally to a system and method for planning workforce resource requirements for task management and resolution.

### BACKGROUND

A typical workforce planning technique may include an Application Management Services (AMS) provider contracted with a business client to assume the responsibility for many application management tasks including, for example, developing and testing application enhancements, and software maintenance and support. Requests for application management tasks may be submitted as service tickets that are logged into a service ticket management system. The service ticket is subsequently assigned to a consultant, who works to resolve the ticket, at which time, the consultant marks the service ticket as resolved, and closes the service ticket.

A service ticket may assume many states during its lifecycle. Initially, the service ticket is in an open state, when the service ticket is opened and while the consultant works on a resolution of one or more issues. The service ticket may also be placed in a waiting state if the consultant can make no further progress until the customer performs an activity, such as providing more data or testing a possible solution. A consultant may be assigned to work on several service tickets simultaneously, each service ticket potentially having a different priority.

Typically, a service ticket management system only records the timestamps for a limited number of states, for example, the open timestamp and the resolved timestamp for the service ticket. Service tickets managed within this type of service ticket management system typically yield a resolution time, which could be defined as the elapsed time between a service ticket's resolved time and the service ticket's open time. However, a more meaningful metric for workgroup resource calculation is the service ticket effort time, which measures the actual time a consultant works on a service ticket. Since a consultant is likely to be working on several service tickets simultaneously, each in an open state, the calculation of a service ticket's effort time will be inaccurately measured in a typical service management system because the typical analysis does not take the above multi-tasking into account. As a result, a consultant's working time is counted towards the open time of each service ticket of a plurality of open service tickets, even though the consultant can only work on one service ticket at any point in time. Thereby, current service management systems result in inherent inaccuracy in terms of service ticket effort.

Accounting for a consultant's time utilization is further complicated when the consultant is assigned to other tasks, such as development work, in addition to working on service tickets. The consultant may be required to use more than one Time-Value Capture (TVC) tool to report time spent on all work assignments, which include both service ticket and non-service ticket tasks. This manual procedure is time-consuming, intrusive to some extent, and error prone, since multiple entries may be required to account for each task the consultant performed during the consultant's work day. Further, the consultant may be required to interrupt a high priority task to make an entry into a time reporting tool, thereby affecting the consultant's productivity. The manual nature of the time reporting process, along with the often difficult user interface of a TVC can result in inaccurate time reporting because the accuracy of the result depends on a consultant making the correct entries in a timely manner. In the multi-tasking environment as described above, there is a need for a tool to create an accurate view of a consultant's utilization time and effort on one or more tasks or service tickets.

To effectively forecast workforce requirements, it would be desirable to provide an improved system and method of calculating task efforts, e.g., service ticket efforts and applying the results for resource planning

### BRIEF SUMMARY

This embodiment of the invention describes a system and method for evaluating the workforce requirements where the workforce consists of a plurality of consultants assigned to computer-related service tickets, such as assisting a user community. Here, a consultant is defined as a professional trained in computer technology. In another embodiment, a consultant may be any worker or service provider assigned to a task that has a measurable duration. In this embodiment, a service ticket is a task performed in support of a computer technology, such as computer hardware, operating system, or software application. In another embodiment, a service ticket may be any request to dispatch a worker to a task.

According to an aspect of the invention, a method for calculating task efforts of a consultant and applying the results for resource planning, comprises: receiving task data into a computer for a plurality of tasks, the computer having a processor for executing a software program tool, the received task data including data parameters based on each of the tasks, respectively; determining a total number of the tasks handled by a consultant during a period of time; dividing the period of time for the total number of tasks handled into a plurality of equal intervals of time; determining a total number of the overlapping tasks within each of the equal intervals of time for the consultant; apportioning a weighted value to each of the tasks handled for each of the equal time intervals according to one or more rules including: a task handling rule or a parallel task rule, using the software program tool; and calculating a task effort value for each of the tasks handled by the consultant by totaling the weighted values for each of the tasks handled.

In another aspect of the invention, a computer program product for calculating task efforts of a consultant and applying the results for resource planning, the computer program product including a program embodied on a computer readable storage medium, the program including code executable by a processor to perform a method comprises: receiving task data into a computer for a plurality of tasks, received task data including data parameters based on each of the tasks, respectively; determining a total number of the tasks handled by a consultant during a period of time; dividing the period of time for the total number of tasks handled into a plurality of equal intervals of time; determining a total number of the overlapping tasks within each of the equal intervals of time for the consultant; apportioning a weighted value to each of the tasks handled for each of the equal time intervals according to one or more rules including: a task handling rule or a parallel task rule; and calculating a task effort value for each of the tasks handled by the consultant by totaling the weighted values for each of the tasks handled.

In another aspect of the invention, a system for calculating task efforts of a consultant and applying the results for resource planning, comprises: a computer for receiving input data, the computer having a processor for executing a software program tool embodied on a computer readable storage medium, the software program tool including task data and including data parameters based on a plurality of respective tasks; a task handling module of the software program tool configured to determine a total number of the tasks handled by a consultant during a period of time, the period of time for the total number of tasks handled being divided into a plurality of equal intervals of time, and a total number of the overlapping tasks being determined within each of the equal intervals of time for the consultant; a rule module of the software program tool configured to apportion a weighted value to each of the tasks handled for each of the equal time intervals according to one or more rules including: a task handling rule or a parallel task rule; and a calculating module of the software program tool configured to calculate a task effort value for each of the tasks handled by the consultant by totaling the weighted values for each of the tasks handled.

### BRIEF DESCRIPTION OF THE SEVERAL VIEWS OF THE DRAWING

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a schematic block diagram of a computer system and inputs according to an embodiment of the invention;

FIG. 2 is a flow chart illustrating an overview of an embodiment of a method according to the present invention, which uses the system shown in FIG. 1;

FIG. 3 is a flow chart illustrating a process flow of effort calculation, in accordance with the method shown in FIG. 2; and

FIG. 4 is a block diagram of an example of effort calculation for two service tickets according to the method shown in FIG. 2.

### DETAILED DESCRIPTION

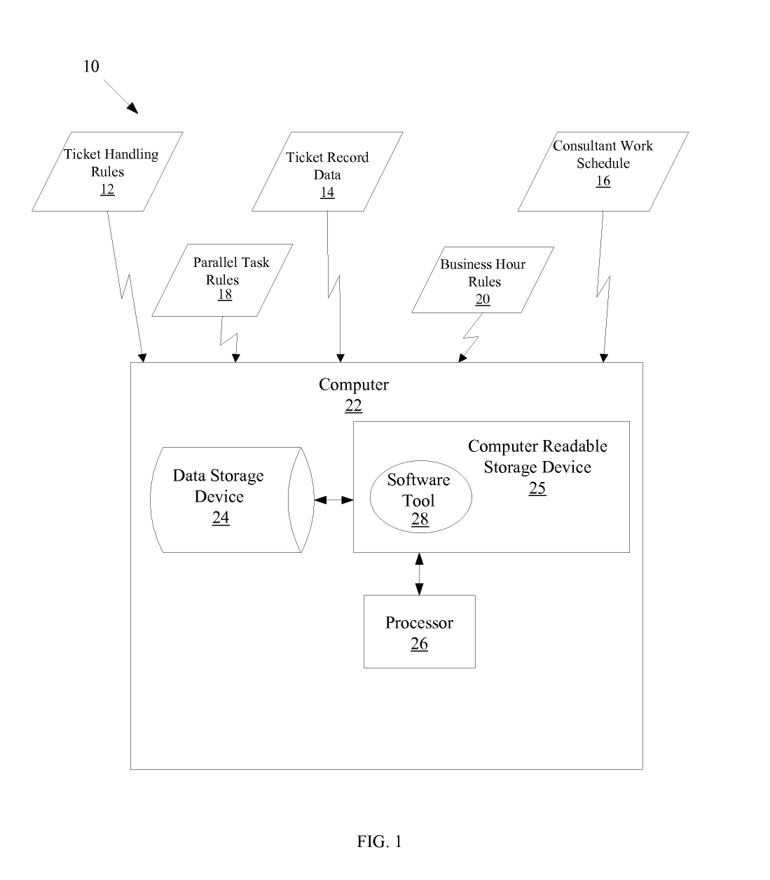

In one embodiment of the invention, referring to FIGS. 1-4, a method 100 for calculating a task effort of a service and applying the results for resource planning includes using a computer system 10 having data inputted as shown in FIG. 1. The consultant may include, for example, a service provider for a task, such as a help desk representative for a help desk service ticket. The inputted data may include, for example, task data, work environment rules and data about the service provider, as well as, task queuing rules, which are embodied as data entry boxes 12, 14, 16, 18, 20 in FIG. 1. The data is inputted into a software program tool 28 of the computer system 10. The software program tool 28 (also referred to a software tool) may be executed by a processor 26 of a computer 22. The software program tool 28 may be saved on a computer readable storage medium 25 or may reside on a portion of the data storage device 24. The computer readable storage medium 25 may include a hard drive, network attached storage, read-only memory, or flash memory. The method 100 further includes inputting task data embodied as service ticket record data 14 (FIG. 1) into the software program tool 28 in step 105 for a plurality of tasks. The service ticket record data 14 inputted in step 105 may include data parameters based on each of the service tickets, respectively, for example, timestamps representing various stages of the service ticket's life cycle, a code indicating the service ticket's handling priority, and an identifier associated with a consultant. The method 100 further includes determining a total number of the service tickets handled by a consultant during a period of time. The consultant may be a help desk provider/consultant.

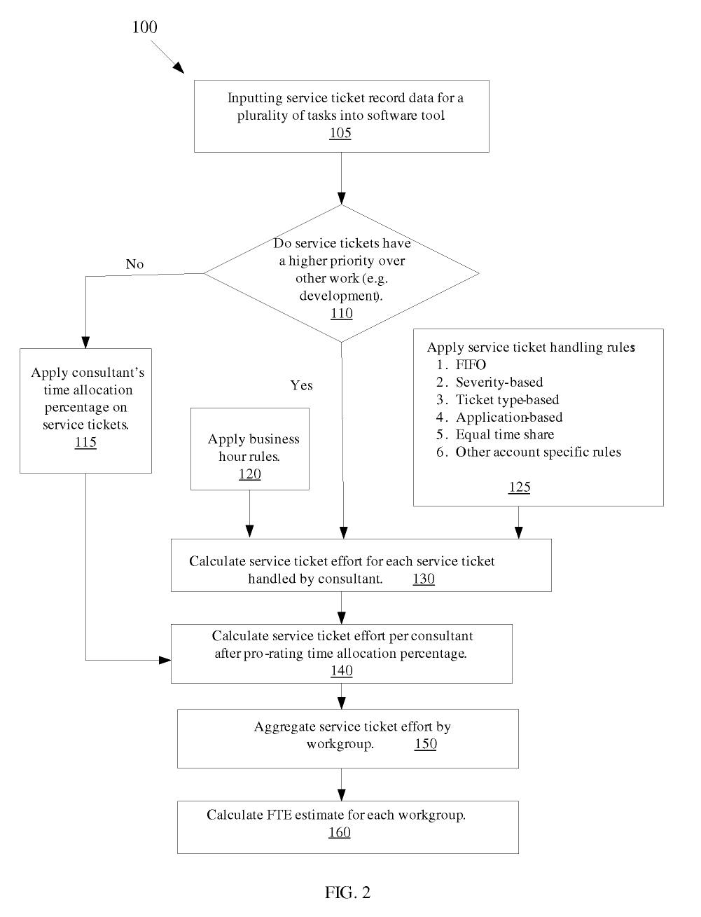

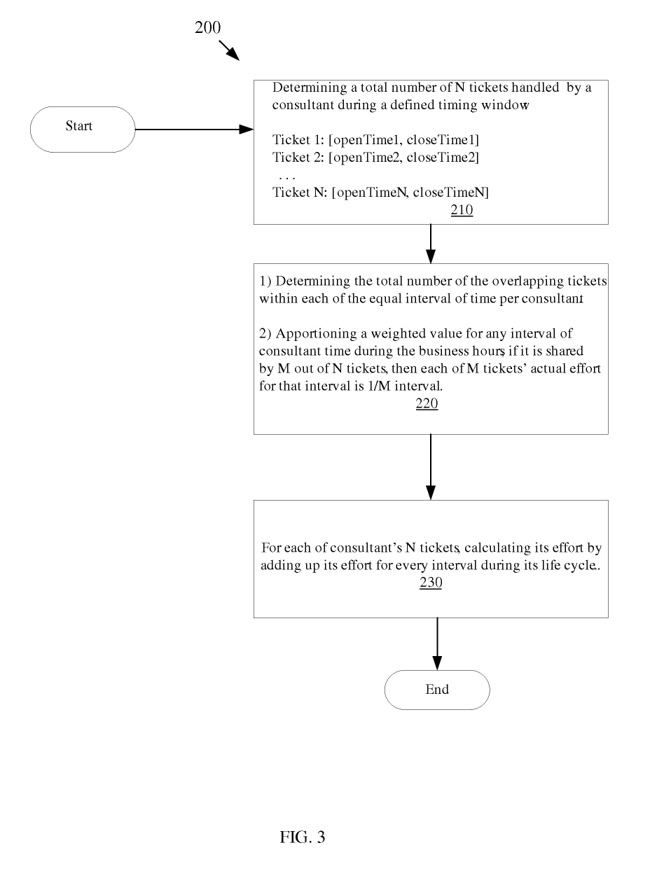

A period of time for a consultant to handle a service ticket may be divided for the total number of task handled into a plurality of equal intervals of time, and overlapping tasks within each of the equal intervals of time can be determined, as in steps 210 and 220 of FIG. 3. The method 100 further apportions a weighted value to each of the tasks handled according to one or more rules, as shown in step 220 of FIG. 3, collectively referred to as business rules which are shown as inputted into the computer 22 in FIG. 1. The aforementioned rules include: parallel task rules 18; business hour rules 20; ticket handling rules 12; and consultant work schedule 16, as shown in FIG. 1. Where the consultant's work schedule includes other tasks in addition to service ticket handling, a parallel task rule 18, for example a percentage or other algorithm, may be applied to the service ticket effort calculation in step 115 resulting in a pro-rated service ticket effort per consultant, which step and the additional steps of the method are discussed in more detail below. A task effort value may be embodied as a service ticket effort for each consultant which is calculated, as in steps 210-230 of FIG. 3 and discussed in detail below. Additionally, a total of service ticket efforts for all consultants in a workgroup may be aggregated by designated workgroup, as in steps 150 and 160 of FIG. 2, to calculate a full time equivalent (FTE) workgroup requirement for the workgroup. In resource planning, the FTE may be represented as the ratio of the total number of hours scheduled to work during a period to the number of available working hours in that period. The ratio units are FTE units, also known as equivalent employees working full-time. For example, an employee working 20 hours out of a 40 hour work week represents 0.50 FTE, and two such employees together represent one FTE. Similarly, an employee working 40 hours in a 40 hour work week represents one FTE, commonly called a full-time employee in this example.

More particularly, referring to FIG. 2, in step 105 of the method 100, the ticket record data 14 for tasks is input for each consultant into the software tool 28. The ticket record data 14 may be an output from a dedicated service ticket management system (not shown), which may co-reside with the software tool 28, but operate independently. The ticket record data 14 may be input to the software tool 28 using one of more modes and stored on the data storage device 24 of the computer 22. In one embodiment, the ticket record data 14 may be entered using a keyboard according to a defined record layout. In this embodiment, ticket record data 14 may also be entered using an optical mark recognition (OMR) scanner, an optical character recognition (OCR) scanner, or barcode reader attached to the computer 22. Similarly, the ticket record data 14 may be input to the software tool 28 using a Universal Serial Bus (USB) device, such as a flash drive, DVD drive, or hard disk drive (HDD) attached to the computer 22. In another embodiment, the ticket record data 14 may be transmitted to the computer 22 using a general file transfer protocol, for example File Transfer Protocol (FTP) or Secure Copy Protocol (SCP), and a network protocol, such as TCP/IP over a wired or wireless LAN. Alternatively, the ticket record data 14 may be input to the software tool 28 from a Storage Area Network (SAN) device such as a disk array, tape library, or optical jukebox that is connected to both the computer 22 and the service ticket management system.

Where a consultant has multiple work assignments, a service ticket effort calculation may include parallel task rules 18 which apportion and prioritize the consultant's time between service tickets and other work assignments. In step 110 of the method 100, a consultant's work assignment may default to service tickets as the highest work priority. Alternatively, in step 115 a consultant may have multiple work assignments according to the consultant's level of experience. For example, a senior consultant may spend a proportionately larger amount of time on software development assignments rather than on service tickets, where an entry level consultant may work exclusively on service tickets. The parallel task rules 18 may be defined by the business client of the AMS provider and input into the software tool 28.

Step 125 includes service ticket handling rules to a service ticket. Service ticket handling rules may be defined by the AMS provider's business client, and may include rules based on: First-In-First-Out (FIFO), severity, application, equal time share, service ticket type, line of business, and may include other account-based rules. In one example of a severity-based rule, service tickets may be handled in order of their assigned severity, such as 1 for a critical system outage, 2 for a severely impaired system, and 3 for how-to questions. If a consultant is working on a severity 2 service ticket and a new severity 1 service ticket arrives, applying a severity-based rule, the consultant stops working on the severity 2 service ticket and begins working on the severity 1 service ticket. When the severity 1 service ticket is resolved, the consultant resumes working on the severity 2 service ticket. However, since both service tickets were open at the same time, a prior art service ticket management system may treat each service ticket as if the consultant were working on each one of the tickets exclusively; thereby, double counting the consultant's working time. In contrast, the present disclosure applies a plurality of factors, such as the consultant's work schedule, parallel task processing rules, and the business's various business rules, to determine which service ticket is being handled by the consultant at a given time.

In one example, the AMS provider's business client may define a ticket handling rule 12 that each application receives a percentage of the available service time. Where three of Application A's service tickets are handled for each one of Application B's service tickets, Application A receives seventy-five percent of the available service time to Application B's twenty-five percent. The plurality of ticket handling rules 12 may be applied collectively, singularly, or in any combination to the service tickets.

Step 120 applies business hour rules 20 that may be defined by the AMS provider's business client and tailored to accommodate various geographical locations and holiday customs. For example, a work location in North America may operate from 9 AM to 6 PM, but a work location in Europe may operate from 8 AM to 5 PM. At another level of business hour rule definition, a critical software application may be assigned continuous operating hours, called 24×7. At the workgroup level, a consultant's work schedule may be defined to coincide with the work location's business hours, or may be adjusted to cover a portion of a 24×7 schedule. For example, assuming a consultant who only works on service ticket assignments and has a work schedule of Monday through Friday and 9 AM to 6 PM, and applying a work location rule and the consultant's work schedule, a service ticket assigned on Monday at 3 PM and resolved at 10 AM Tuesday, should have an open time of four hours.

Step 130 of the method 100 calculates the service ticket effort for each service ticket a consultant works on and is illustrated by a sub-method 200, shown in FIG. 3. Step 210 of FIG. 3 includes an assumption of an equal time share rule for service ticket handling. In step 210, service ticket data for the defined time period is grouped by consultant, with the total of all service tickets for a consultant represented as N service tickets. In step 220, a count, represented by M, is created. For any interval of the consultant's time that is during a defined business hour and within the consultant's work schedule, if the interval is shared by M out of N service tickets, then the service ticket effort for each service ticket during the interval under investigation may be represented as:

SERVICE TICKET EFFORT=1/M

Step 230 includes calculating the effort for a service ticket by adding up the individual efforts for every interval of its life cycle as calculated in step 220. In step 140 of FIG. 2, where the consultant's work assignments include other tasks in addition to service ticket handling, a parallel task rule 18, for example a percent of time allocated to task handling, or other algorithm may be applied to the effort for a service ticket resulting in a pro-rated final service ticket effort per consultant. A task handling module may be embodied as the task handling rules for calculating task handling with the software tool. The software tool may include a calculating module for calculating the effort for a service ticket. A rules module may be embodied as the parallel task rules and the business hour rules inputted into the software tool.

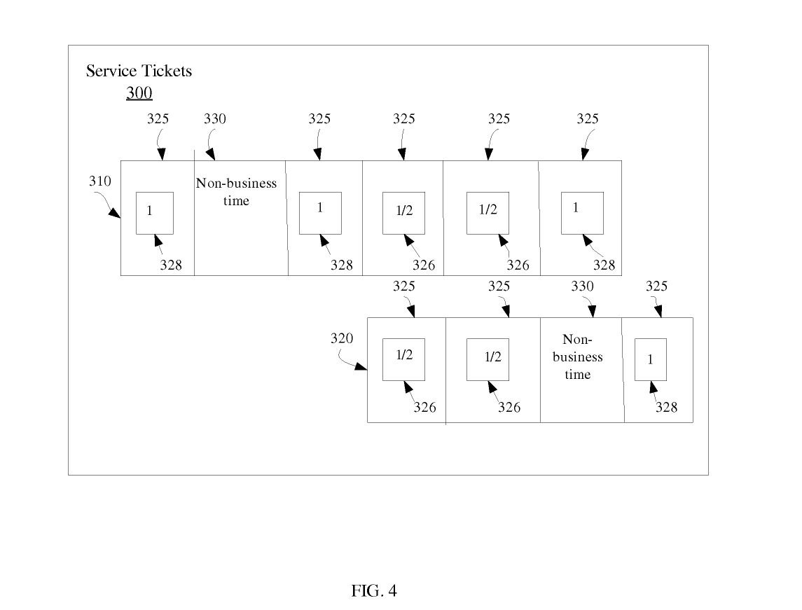

Referring to FIG. 4, an example of multiple service tickets 300 assumes an equal time share and uses two service tickets, referred to as a first service ticket 310 and a second service ticket 320, to illustrate the overlapping service tickets according to the method of the disclosure. The example shown in FIG. 4 uses a one minute interval to illustrate the method of the disclosure. However, the length of the interval is a configurable business rule that may be used to affect the granularity of the measurement. In the service tickets 310, 320 shown in FIG. 4, each block 325 represents a one minute interval, and the service ticket time blocks 325 are placed in a time spaced relation to each other to illustrate the passing of time from left to right, such that overlapping time blocks are illustrated. In the first service ticket 310, time blocks 325 occupy six minutes in its life cycle. The second service ticket 320 has a life cycle of four minutes. Two minutes that are non-business time 330 may represent time not included in the consultant's work schedule or may be time excluded from the business hour rules. The other time blocks are considered as business time blocks.

In FIG. 4, the first service ticket 310 and the second service ticket 320 are concurrently open for two one minute blocks 325. Each minute is inspected for the earliest open timestamp in the ticket record data 14. To calculate M, count how many service tickets: 1) share the minute; 2) are within the consultant's work schedule; and 3) are within the client's business hour rules. The fourth minute of the first ticket 310 overlaps with the first minute of the second service ticket 320, which results in a value for M of 2. The consultant's effort for each service ticket during the overlapping minute is 1/M, or ½ minute 326. Where a service ticket does not share a minute block, as in the last minute of the second service ticket 320, the calculation still applies as 1/1, or 1 minute 328. The non-business time blocks are represented as 0/1, or 0 minutes (not shown). The service ticket effort for a service ticket is the sum of all efforts over the lifecycle of the service ticket:

FIRST SERVICE TICKET 310 EFFORT=1+0+1+½+½+1=4

SECOND SERVICE TICKET 320 EFFORT=½+½+0+1=2

In step 150 of FIG. 2, the service ticket effort for a workgroup is calculated by summing up the service ticket efforts for all service tickets assigned to the workgroup.

Finally, in step 160, the FTE for each workgroup is calculated as the service ticket effort for the workgroup/total number of hours available for an FTE to work per year.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for calculating task efforts of a consultant and applying the results for resource planning, comprising:
receiving task data into a computer for a plurality of tasks, the computer having a processor for executing a software program tool, the received task data including data parameters based on each of the tasks, respectively;
determining a total number of the tasks handled by a consultant during a period of time;
dividing the period of time for the total number of tasks handled into a plurality of equal intervals of time;
determining a total number of the overlapping tasks within each of the equal intervals of time for the consultant using the software program tool;
apportioning a weighted value to each of the tasks handled for each of the equal time intervals according to one or more rules including: a task handling rule or a parallel task rule, using the software program tool; and
calculating a task effort value for each of the tasks handled by the consultant by totaling the weighted values for each of the tasks handled.

2. The method of claim 1, wherein the overlapping tasks include a multiplicity of the tasks being open during a defined business hour and within the consultant's work schedule.

3. The method of claim 1, wherein the task value for a workgroup comprises: aggregating the task effort values for a plurality of consultants within the workgroup.

4. The method of claim 3, wherein a FTE for a workgroup comprises a ratio of a plurality of task effort values per the workgroup to a total available work hours for the FTE.

5. The method of claim 1, wherein the parallel task rule includes one or more of: a percent of time allocated to task handling; and a priority of task work over other assigned activities.

6. The method of claim 1, wherein the period of time comprises an elapsed time between an earliest open timestamp for a task and a latest closed timestamp for a task.

7. The method of claim 1, wherein the task handling rule includes one or more of: a FIFO rule; a severity-based rule; a task type-based rule; an application-based rule; an equal time share rule; a percentage assignment; a line of business rule; or an account-based rule.

8. The method of claim 1, wherein a workgroup comprises a plurality of consultants in the workgroup.

9. A computer program product for calculating task efforts of a consultant and applying the results for resource planning, the computer program product including a program embodied on a computer readable storage medium, the program including code executable by a processor to perform a method comprising:
receiving task data into a computer for a plurality of tasks, the computer having a processor for executing a software program tool, the received task data including data parameters based on each of the tasks, respectively;
determining a total number of the tasks handled by a consultant during a period of time;
dividing the period of time for the total number of tasks handled into a plurality of equal intervals of time;
determining a total number of the overlapping tasks within each of the equal intervals of time for the consultant;
apportioning a weighted value to each of the tasks handled for each of the equal time intervals according to one or more rules including: a task handling rule or a parallel task rule; and
calculating a task effort value for each of the tasks handled by the consultant by totaling the weighted values for each of the tasks handled.

10. The computer program product of claim 9, wherein the overlapping tasks include a multiplicity of the tasks being open during a defined business hour and within the consultant's work schedule.

11. The computer program product of claim 9, wherein the task value for a workgroup comprises: aggregating the task effort values for a plurality of consultants within the workgroup.

12. The computer program product of claim 9, wherein a FTE for a workgroup comprises a ratio of the task effort values per the workgroup to the total available work hours for the FTE.

13. The computer program product of claim 9, wherein the parallel task rule includes one or more of: a percent of time allocated to service ticket handling; and a priority of service ticket work over other assigned activities.

14. The computer program product of claim 9, wherein the period of time comprises an elapsed time between an earliest open timestamp for a task and a latest closed timestamp for a task.

15. The computer program product of claim 9, wherein the task handling rule includes one or more of: a FIFO rule; a severity-based rule; a task type-based rule; an application-based rule; an equal time share rule; a percentage assignment; a line of business rule; or an account-based rule.

16. The computer program product of claim 9, wherein a workgroup comprises a plurality of consultants in the workgroup.

17. A system for calculating task efforts of a consultant and applying the results for resource planning, comprising:
a computer for receiving input data, the computer having a processor for executing a software program tool embodied on a computer readable storage medium, the software program tool including task data and including data parameters based on a plurality of respective tasks;
a task handling module of the software program tool configured to determine a total number of the tasks handled by a consultant during a period of time, the period of time for the total number of tasks handled being divided into a plurality of equal intervals of time, and a total number of the overlapping tasks being determined within each of the equal intervals of time for the consultant;
a rule module of the software program tool configured to apportion a weighted value to each of the tasks handled for each of the equal time intervals according to one or more rules including: a task handling rule or a parallel task rule; and
a calculating module of the software program tool configured to calculate a task effort value for each of the tasks handled by the consultant by totaling the weighted values for each of the tasks handled.

18. The system of claim 17, wherein the parallel task rule includes one or more of: a percent of time allocated to service ticket handling; and a priority of service ticket work over other assigned activities.

19. The system of claim 17, wherein the period of time comprises an elapsed time between an earliest open timestamp for a task and a latest closed timestamp for a task.

20. The system of claim 17, wherein the task handling rule includes one or more of: a FIFO rule; a severity-based rule; a task type-based rule; an application-based rule; an equal time share rule; a percentage assignment; a line of business rule; or an account-based rule.
